(19) United States
(12) Patent Application Publication
(10) Pub. No.: US 2011/0139410 A1
(43) Pub. Date: Jun. 16, 2011

(54) Floating Coil Heat Exchanger

(75) Inventors: Stephen Troutman, Stone Mountain, GA (US); Chris Jentzsch, Snellville, GA (US); Dustan Atkinson, Stone Mountain, GA (US); Lindsay Harry, Atlanta, GA (US)

(73) Assignee: LENNOX INTERNATIONAL, INC., Ricihardson, TX (US)

(21) Appl. No.: 12/750,881

(22) Filed: Mar. 31, 2010

Related U.S. Application Data
(60) Provisional application No. 61/286,854, filed on Dec. 16, 2009.

(51) Int. Cl. G06F 1/20; F28F 9/02; F28F 1/00; B23P 15/26

(52) U.S. Cl. 165/121; 165/173; 165/177; 165/181; 29/890.054

(57) ABSTRACT

The present application provides a heat exchanger assembly. The heat exchanger assembly may include a microchannel coil and a frame. The frame may include a slot to position the microchannel coil therein. A coil attachment may connect the microchannel coil at a first end of the frame.

### RELATED APPLICATIONS

The present application claims priority to U.S. Provisional Application Ser. No. 61/286,854 filed on Dec. 16, 2009. This application is incorporated herein by reference in full.

### TECHNICAL FIELD

The present application relates generally to air conditioning and refrigeration systems and more particularly relates to a floating microchannel heat exchanger or condenser coil for use in condenser assemblies and the like so as to provide support and access thereto.

### BACKGROUND OF THE INVENTION

Modern air conditioning and refrigeration systems provide cooling, ventilation, and humidity control for all or part of an enclosure such as a building, a cooler, and the like. Generally described, the refrigeration cycle includes four basic stages to provide cooling. First, a vapor refrigerant is compressed within a compressor at high pressure and heated to a high temperature. Second, the compressed vapor is cooled within a condenser by heat exchange with ambient air drawn or blown across a condenser coil by a fan and the like. Third, the liquid refrigerant is passed through an expansion device that reduces both the pressure and the temperature of the liquid refrigerant. The liquid refrigerant is then pumped within the enclosure to an evaporator. The liquid refrigerant absorbs heat from the surroundings in an evaporator coil as the liquid refrigerant evaporates to a vapor. Finally, the vapor is returned to the compressor and the cycle repeats. Various alternatives on this basic refrigeration cycle are known and also may be used herein.

Traditionally, the heat exchangers used within the condenser and the evaporator have been common copper tube and fin designs. These heat exchanger designs often were simply increased in size as cooling demands increased. Changes in the nature of the refrigerants permitted to be used, however, have resulted in refrigerants with distinct and sometimes insufficient heat transfer characteristics. As a result, further increases in the size and weight of traditional heat exchangers also have been limited within reasonable cost ranges.

As opposed to copper tube and fin designs, recent heat exchanger designs have focused on the use of aluminum microchannel coils. Microchannel coils generally include multiple flat tubes with small channels therein for the flow of refrigerant. Heat transfer is then maximized by the insertion of angled and/or louvered fins in between the flat tubes. The flat tubes are then joined with a number of manifolds. Compared to known copper tube and fin designs, the air passing over the microchannel designs has a longer dwell time so as to increase the efficiency and the rate of heat transfer. The increase in heat exchanger effectiveness also allows the microchannel heat exchangers to be smaller while having the same or improved performance and the same volume as a conventional heat exchanger. Microchannel coils thus provide improved heat transfer properties with a smaller size and weight, provide improved durability and serviceability, improved corrosion protection, and also may reduce the required refrigerant charge by up to about fifty percent (50%).

Both copper fin and tube heat exchangers and aluminum microchannel heat exchangers generally are firmly attached to the condenser or the evaporator as an integral portion of the overall structure. Traditional copper fin and tube heat exchangers generally had the ability to flex somewhat during changes in temperature and the resultant expansion and contraction associated therewith. Aluminum microchannel heat exchangers, however, generally have somewhat less of an ability to flex, expand, and contract. Moreover, the entire condenser and/or evaporator assembly generally must be disassembled in order to access and/or replace the microchannel coils and other components.

There is therefore a desire therefore for an improved microchannel heat exchanger design. Such a microchannel heat exchanger design should be easy to install, access, and remove from a condenser, evaporator, or otherwise and also should provide the ability for sufficient expansion and contraction without causing harm to the overall structure.

### SUMMARY OF THE INVENTION

The present application thus provides a heat exchanger assembly. The heat exchanger assembly may include a microchannel coil and a frame. The frame may include a slot to position the microchannel coil therein. A coil attachment may connect the microchannel coil at a first end of the frame.

The heat exchanger assembly further may include a rear bracket connecting the microchannel coil at a second end of the frame. The microchannel coil may slide within the slot. The microchannel coil may include a coil manifold. The coil attachment may include a clamp positioned about the coil manifold. The coil attachment may include a rubber or polymeric bushing. The heat exchanger assembly further may include a fan positioned about the microchannel coil.

The heat exchanger assembly further may include an assembly inlet manifold and an assembly outlet manifold in fluid communication with the coil manifold. The coil manifold may include a coil manifold inlet brazed to the assembly inlet manifold and a coil manifold outlet brazed to the assembly outlet manifold. Other connections may be used herein.

The microchannel coil may include a number of microchannel coils. The microchannel coil may include a number of flat microchannel tubes with a number of fins extending therefrom. The microchannel coil may include an extruded aluminum and the like.

The present application further may provide a method of installing a microchannel coil within a heat exchanger assembly. The method may include the steps of sliding the microchannel coil into a slot within the heat exchanger assembly, attaching a manifold of the microchannel coil to a first end of the frame, and brazing an attachment between the manifold of the microchannel coil and one or more manifolds of the heat exchanger assembly.

The step of attaching a manifold of the microchannel coil to a first end of the frame may include vibrationally isolating the manifold from the frame. The method further may include the step of attaching the microchannel coil to a second end of the frame. The method further may include the step of charging the microchannel coil with refrigerant.

The present application further provides a condenser assembly. The condenser assembly may include a microchannel coil and a frame. The frame may include a slot to position the microchannel coil therein. A clamp and a bushing may connect the microchannel coil at a first end of the frame and a rear bracket may connect the microchannel coil at a second end of the frame.

The microchannel coil may include a coil manifold. The clamp may be positioned about the coil manifold. The bushing may include a rubber or polymeric bushing. The microchannel coil may slide within the slot. The microchannel coil may include a number of microchannel coils.

These and other features and improvements of the present application will become apparent to one of ordinary skill in the art upon review of the following detailed description when taken in conjunction with the several drawings and the appended claims.

### BRIEF DESCRIPTION OF THE DRAWINGS

FIG. 1 is a perspective view of a portion of a microchannel coil as may be used herein.

FIG. 2 is a side cross-sectional view of a portion of the microchannel coil of FIG. 1.

FIG. 3 is a perspective view of a microchannel condenser assembly as is described herein.

FIG. 4 is a partial exploded view of a microchannel coil being installed within the microchannel condenser assembly of FIG. 3.

FIG. 5 is a partial perspective view of the microchannel coil installed at a first end of the microchannel condenser assembly of FIG. 3.

FIG. 6 is a partial perspective view of the microchannel coil attached at a second end of the microchannel condenser assembly of FIG. 3.

### DETAILED DESCRIPTION

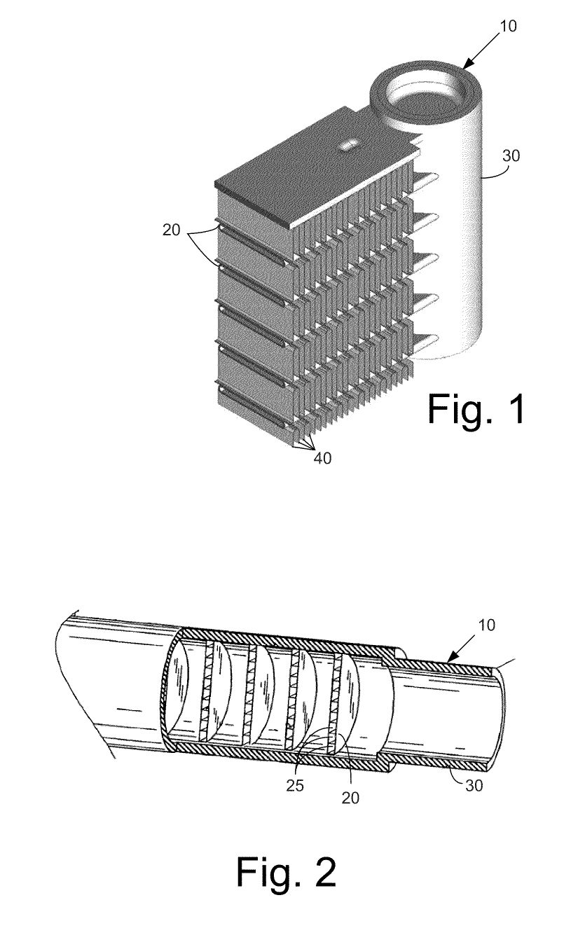

Referring now to the drawings, in which like numerals refer to like elements throughout the several views, FIGS. 1 and 2 show a portion of a known microchannel coil 10 similar to that described above. Specifically, the microchannel coil 10 may include a number of microchannel tubes 20 with a number of microchannels 25 therein. The microchannel tubes 20 are generally elongated and substantially flat. Each microchannel tube 20 may have any number of microchannels 25 therein. A refrigerant flows through the microchannels 25 in various directions.

The microchannel tubes 20 generally extend from one or more manifolds 30. The manifolds 30 may be in communication with the overall air-conditioning system as is described above. Each of the microchannel tubes 20 may have a number of fins 40 positioned thereon. The fins 40 may be straight or angled. The combination of a number of small tubes 20 with the associated high density fins 40 thus provides more surface area per unit volume as compared to known copper fin and tube designs for improved heat transfer. The fins 40 also may be louvered over the microchannel tubes 20 for an even further increase in surface area. The overall microchannel coil 10 generally is made out of extruded aluminum and the like.

Examples of known microchannel coils 10 include those offered by Hussmann Corporation of Bridgeton, Mo.; Modine Manufacturing Company of Racine, Wis.; Carrier Commercial Refrigeration, Inc. of Charlotte, N.C.; Delphi of Troy, Mich.; Danfoss of Denmark; and from other sources. The microchannel coils 10 generally may be provided in standard or predetermined shapes and sizes. Any number of microchannel coils 10 may be used together, either in parallel, series, or combinations thereof. Various types of refrigerants may be used herein.

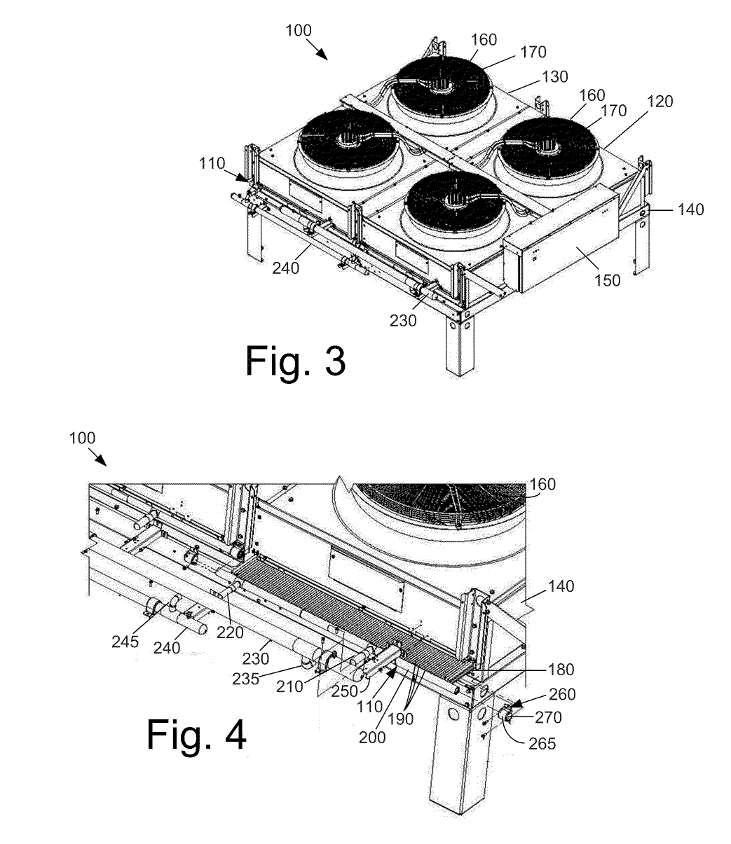

FIG. 3 shows a microchannel condenser assembly 100 as may be described herein. The microchannel condenser assembly 100 may include a number of microchannel coils 110. The microchannel coils 110 may be similar to the microchannel coil 10 described above or otherwise. Although two micro-channel coils 110 are shown, a first microchannel coil 120 and a second microchannel coil 130, any number of microchannel coils 110 may be used herein. As described above, the microchannel coils 110 may be connected in series, in parallel, or otherwise.

The microchannel coils 110 may be supported by a frame 140. The frame 140 may have any desired shape. Operation of the microchannel coils 110 and the microchannel condenser assembly 100 as a whole may be controlled by a controller 150. The controller 150 may or may not be programmable. A number of fans 160 may be positioned about each microchannel coil 110 and the frame 140. The fans 160 may direct a flow of air across the microchannel coils 110. Any number of fans 160 may be used herein. Other types of air movement devices also may be used herein. Each fan 160 may be driven by an electrical motor 170. The electrical motor 170 may operate via either an AC or a DC power source. The electrical motors 170 may be in communication with the controller 150.

FIG. 4 shows the insertion of one of the microchannel coils 110 into a slot 180 within the frame 140 of the microchannel condenser assembly 100. As is shown and as is described above, the microchannel coil 110 includes a number of microchannel tubes 190 in communication with a coil manifold 200. The coil manifold 200 has at least one coil manifold inlet 210 and at least one a coil manifold outlet 220. Refrigerant passes into the microchannel coil 110 via the coil manifold inlet 210, passes through the microchannel tubes 190 with the microchannels therein, and exits via the coil manifold outlet 220. The refrigerant may enter as a vapor and exit as a liquid as the refrigerant exchanges heat with the ambient air. The refrigerant also may enter as a liquid and continue to release heat therein.

The microchannel condenser assembly 100 likewise may include an assembly inlet manifold 230 with an assembly inlet connector 235 and an assembly outlet manifold 240 with an assembly outlet connector 245. The assembly inlet manifold 230 is in communication with the coil manifold 200 via the coil manifold inlet 210 and the assembly inlet connector 235 while the assembly outlet manifold 240 is in communication with the coil manifold 200 via the coil outlet manifold 220 and the assembly outlet connector 245. Other connections may be used herein. The assembly manifolds 230, 240 may be supported by one or more brackets 250 or otherwise. The assembly manifolds 230, 240 may be in communication with other elements of the overall refrigeration system as was described above.

The coil manifold inlets and outlets 210, 220 and/or the assembly connectors 235, 245 may include stainless steel with copper plating at one end. The coil inlets and outlets 210, 220 and the assembly connectors 235, 245 may be connected via a brazing or welding operation and the like. Because the copper and the aluminum do not come into contact with one another, there is no chance for galvanic corrosion and the like. Other types of fluid-tight connections and/or quick release couplings may be used herein.

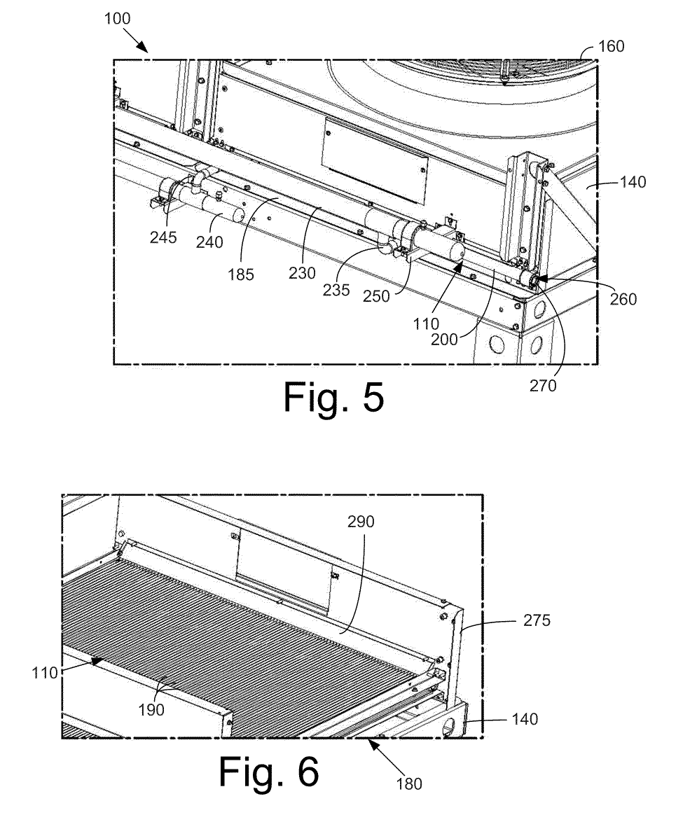

FIG. 5 shows one of the microchannel coils 110 installed within the slot 180 of the frame 140 at a first end 185 thereof. As described above, the coil manifold 200 may be in communication with the assembly inlet and outlet manifolds 230, 240. The coil manifold 200 also may be attached to the frame 140 at the first end 185 via a coil attachment 260. The coil attachment 260 may include a clamp 265 that surrounds the coil manifold 200 and is secured to the frame 140 via screws, bolts, other types of fasteners, and the like. Other shapes may be used herein. A rubber or polymeric bushing 270 also may be used between the manifold 200 and the clamp 265 so as to dampen any vibrations therein. Other types of isolation means may be used herein.

FIG. 6 shows the opposite end of the microchannel coil 110 as installed within the slot 180 at a second end 275 of the frame 140. The slot 180 may extend for the length of the frame 140 or otherwise. The microchannel coil 110 may slide along the slot 180. Alternatively, wheels and/or other types of motion assisting devices may be used herein. The microchannel coil 110 may be held in place via a rear bracket or a tab 290. The rear bracket 290 may be any structure that secures the microchannel coil 110 in place. The rear bracket 290 may be secured to the back of the frame 140 once the microchannel coil 110 has been slid therein. Other types of attachment means and/or fasteners may be used herein.

In use, each microchannel coil 110 may be slid into the slot 180 of the frame 140 of the microchannel condenser assembly 100. Use of the slot 180 ensures that the microchannel coil 110 is positioned properly within the microchannel condenser assembly 100. The microchannel coil 110 then may be secured at the second end 275 via the rear bracket 290. The microchannel manifold 200 at the first end 185 may be secured via the clamp 265 and the rubber or polymeric bushing 270 of the coil attachments 260. The manifold inlets and outlets 210, 220 then may be connected to the assembly manifolds 230, 240 and assembly inlet connections 235, 245 via brazing, welding, or otherwise. The microchannel coils 110 thus are secure but the overall microchannel condenser assembly 100 does not rely on the microchannel coils 110 for support or strength. Rather, the microchannel coils 110 essentially are allowed to “float” within the slot 180 as may be required.

Likewise, the microchannel coil 110 may be easily removed in the reverse order. The charge from the microchannel coil 110 may be removed. The connections for the respective manifolds 200, 230, 240 then may be unsweated. The clamp attachment 260 and the rear bracket 290 may be removed. The microchannel coil 110 then may be slid out of the slot 180. Installation, removal, and repair of the microchannel coil 110 thus may be relatively quick and easy to accomplish.

The use of the clamp 265 and the rubber or polymeric bushing 270 of the coil attachment 260 at the first end 185 and the rear bracket 290 at the second end 275 thus allows the microchannel coils 110 to move sideways during operation of the overall microchannel condenser assembly 100. The micro-channel coils 110 thus are firmly supported and held in place but allowed to flex freely as may be needed. Fatigue failures at the manifold connections therefore may be avoided. The refrigeration carrying components thus are isolated from other elements of the overall assembly 100. Such isolation may avoid leaks and other types of performance issues.

Although the use of the microchannel coils 110 has been described in the context of the microchannel condenser assembly 100, it should be understood that the microchannel coils 100 and the positioning means described herein may be used anywhere a heat exchanger may be needed, such as in an evaporator and the like, so as to provide easy access thereto and the ability to flex, expand, and contract without damage to related elements. The microchannel condenser assembly 100 and the microchannel coils 110 may be used with any type of air conditioning or refrigeration system and the like.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. A heat exchanger assembly, comprising:
a microchannel coil;
a frame;
the frame comprising a slot to position the microchannel coil therein; and
a coil attachment connecting the microchannel coil at a first end of the frame.

2. The heat exchanger assembly of claim 1, further comprising a rear bracket connecting the microchannel coil at a second end of the frame.

3. The heat exchanger assembly of claim 1, wherein the coil attachment comprises a rubber or polymeric bushing.

4. The heat exchanger assembly of claim 1, wherein the microchannel coil comprises a coil manifold and wherein the coil attachment comprises a clamp positioned about the coil manifold.

5. The heat exchanger assembly of claim 4, further comprising an assembly inlet manifold and an assembly outlet manifold in fluid communication with the coil manifold.

6. The heat exchanger assembly of claim 5, wherein the coil manifold comprises a coil manifold inlet brazed to the assembly inlet manifold and a coil manifold outlet brazed to the assembly outlet manifold.

7. The heat exchanger assembly of claim 1, wherein the microchannel coil comprises a plurality of microchannel coils.

8. The heat exchanger assembly of claim 1, wherein the microchannel coil slides within the slot.

9. The heat exchanger assembly of claim 1, wherein the microchannel coil comprises a plurality of flat microchannel tubes with a plurality of fins extending therefrom.

10. The heat exchanger assembly of claim 1, wherein the microchannel coil comprises an extruded aluminum.

11. The heat exchanger assembly of claim 1, further comprising a fan positioned about the microchannel coil.

12. A method of installing a microchannel coil within a heat exchanger assembly, comprising:
sliding the microchannel coil into a slot within the heat exchanger assembly;
attaching a manifold of the microchannel coil to a first end of the frame; and
brazing an attachment between the manifold of the microchannel coil and one or more manifolds of the heat exchanger assembly.

13. The method of installing a microchannel coil of claim 12, further comprising the step of attaching the microchannel coil to a second end of the frame.

14. The method of installing a microchannel coil of claim 12, wherein the step of attaching a manifold of the microchannel coil to a first end of the frame comprises vibrationally isolating the manifold from the frame.

15. The method of installing a microchannel coil of claim 12, further comprising the step of charging the microchannel coil with refrigerant.

16. A condenser assembly, comprising:
a microchannel coil;
a frame;
the frame comprising a slot to position the microchannel coil therein;
a clamp and a bushing connecting the microchannel coil at a first end of the frame; and
a rear bracket connecting the microchannel coil at a second end of the frame.

17. The condenser assembly of claim 16, wherein the bushing comprises a rubber or polymeric bushing.

18. The condenser assembly of claim 16, wherein the microchannel coil comprises a coil manifold and wherein the clamp is positioned about the coil manifold.

19. The condenser assembly of claim 16, wherein the microchannel coil comprises a plurality of microchannel coils.

20. The condenser assembly of claim 16, wherein the microchannel coil slides within the slot.
